(19) United States
(12) Patent Application Publication
(10) Pub. No.: US 2021/0265694 A1
(43) Pub. Date: Aug. 26, 2021

(54) BATTERY HOLDING DEVICE, BATTERY SYSTEM, AIRCRAFT AND METHOD FOR CHANGING A BATTERY FOR AN AIRCRAFT

(71) Applicant: Volocopter GmbH, Bruchsal (DE)

(72) Inventors: Felix Igor Lucien MECKENSTOCK, Karlsruhe (DE); Michael HARMS, Waldbronn (DE); Florian STRUBE, Bietigheim-Bissingen (DE); Tobias GRIMM, Bretten (DE)

(73) Assignee: Volocopter GmbH, Bruchsal (DE)

(21) Appl. No.: 17/183,761

(22) Filed: Feb. 24, 2021

(30) Foreign Application Priority Data
Feb. 24, 2020 (DE) 102020104783.5

(51) Int. Cl. H01M 50/249; B64C 29/00; H01M 50/204; H01M 50/244; H01M 50/264

(52) U.S. Cl. CPC H01M 50/249; B64C 29/00; H01M 2220/20; H01M 50/244; H01M 50/264; H01M 50/204

(57) ABSTRACT

A battery holding device for an electrically driven aircraft, including a battery holder for accommodating at least one battery, a connection for establishing electrical contact between the at least one battery and an electrical drive of the aircraft, and a primary securing device for locking the at least one battery in the battery holder. The important factor is that the battery holding device includes at least one secondary securing device for locking the at least one battery in the battery holder, wherein the secondary securing device can be closed and released independently of the primary securing device. The invention also relates to a battery system, to an aircraft and to a corresponding method.

### INCORPORATION BY REFERENCE

The following documents are incorporated herein by reference as if fully set forth: German Patent Application No. DE 10 2020 104 783.5, filed Feb. 24, 2020.

### TECHNICAL FIELD

The present invention relates to a battery holding device for an electrically driven aircraft, to a battery system for an electrically driven aircraft, to an aircraft and to a method for locking at least one battery in a battery holding device and to a method for changing a battery in a battery holding device.

### BACKGROUND

Aircraft, in particular vertical take-off and landing aircraft, also known as VTOL, are used both to transport persons, autonomously or under the control of an accompanying pilot, and to transport loads, in a remotely controlled or autonomous manner. Such aircraft are increasingly being driven electrically or, for example, in a partially electrical (hybrid) manner. A battery is needed for the electrical drive, usually in the form of an electric motor.

These batteries are usually in the form of secondary batteries, that is to say rechargeable batteries, and must be regularly replaced. The aspect of safety plays a major role when using the batteries and during regular replacement of the batteries (battery swap). In particular in the case of aircraft for transporting persons, it is necessary to comply with high safety requirements which can be complicated by the large number of changing operations.

In this respect, the prior art, for example US 2019259998 A1, discloses a system for locking a battery, which system provides visual feedback regarding whether the battery is locked in the desired manner. Alternatively, US 2012261522 A1 describes a system for locking one or more batteries in an airplane.

The disadvantage of the above-mentioned system from the prior art is that, in the event of failure of the battery locking system, the power supply for the electrical drive of the aircraft and therefore the drive itself can fail. This can result in a crash of the aircraft.

### SUMMARY

Therefore, the present invention is based on the object of providing a battery holding device, an aircraft and a method which make it possible to securely lock the battery and, in particular, to safely change the battery.

This object is achieved by a battery holding device for an electrically driven aircraft having one or more of the features described herein. Advantageous refinements of the battery holding device according to the invention are found below and in the claims. This object is also achieved by a battery system and a vertical take-off and landing aircraft having one or more of the features described herein. The method according to the disclosure for locking a battery and the method according to the disclosure for changing a battery also achieve the object according to the invention. Advantageous refinements of the methods according to the invention are found below and int eh claims. In order to avoid repetitions, the claims are hereby explicitly included in the description by reference.

The battery holding device according to the invention for an electrically driven aircraft comprises, as known per se, a battery holder for accommodating at least one battery. A connection for establishing electrical contact between the at least one battery and an electrical drive of the aircraft is also provided. A primary securing device is provided for the purpose of locking the at least one battery in the battery holder.

The important factor is that the battery holding device comprises at least one secondary securing device for locking the at least one battery in the battery holder, wherein the secondary securing device can be closed and released independently of the primary securing device.

The method according to the invention for locking at least one battery in a battery holding device of an electrically driven aircraft comprises the following method steps

A) inserting the at least one battery into a battery holder of the battery holding device,

B) locking the at least one battery in the battery holder by a primary securing device.

The important factor is that, in a method step

C) the at least one battery is additionally locked in the battery holding device by at least one secondary securing device, wherein the secondary securing device is closed independently of the primary securing device.

The invention is based on the applicant's knowledge that the fit of the battery in a battery holding device of an aircraft is extremely relevant to safety, in particular in the case of a very large number of battery changing operations, and can be significantly improved by the use of a second, independent secondary securing device. As a result of the redundancy of the primary securing device and the secondary securing device, the secure fit of the battery in the battery holding device is nevertheless ensured if one of the two securing device fails, and an accident involving the aircraft is avoided.

Within the scope of this description, the terms “battery”, “secondary battery”, “rechargeable battery” and “rechargeable batteries” are used interchangeably. The device according to the invention and the methods according to the invention can be carried out both using disposable batteries and using rechargeable batteries or other energy stores.

The battery holding device according to the invention and the method according to the invention therefore differ in important aspects from previously known methods:

According to the invention, the secondary securing device is additionally used to provide a second, independent securing device for the battery in the battery holder and a second securing step in the method according to the invention. This makes it possible to prevent the battery from losing electrical contact with the drive of the aircraft or falling out of the battery holding device if the primary battery securing device fails. Such a malfunction would be fatal during ongoing operation of the aircraft, that is to say during flight, and is therefore extremely relevant to safety.

The solution according to the invention makes it possible to ensure in a simple manner that the battery is securely locked in the battery holding device of an aircraft despite repeated changes.

In one preferred embodiment of the invention, the at least one secondary securing device is in the form of a mechanical latching means or is formed by a form fit, in particular is in the form of at least one hook and/or clip. The battery can be easily prevented from falling out of the battery holder by such a secondary securing device.

The connection for establishing electrical contact can be provided as an explicit element, for example as a plug connection. Alternatively, physical contact, which connects the battery to the electrical drive of the aircraft, can be already automatically established by the insertion of the battery.

In one preferred embodiment of the invention, the at least one secondary securing device is designed in such a manner that the connection for establishing electrical contact between the at least one battery and the drive of the aircraft can be established only in a closed state of the secondary securing device.

In particular, the at least one secondary securing device is designed in such a manner that the secondary securing device blocks the connection for establishing electrical contact between the at least one battery and the electrical drive of the aircraft in an open state. This makes it possible to easily ensure that it is possible to start the aircraft only when the secondary securing device is properly closed and the battery is therefore securely locked in the battery holding device.

The secondary securing device may be designed in a wide variety of ways for this purpose, for example by virtue of the secondary securing device blocking the electrical contacts of the battery and/or the connection to the electrical drive of the aircraft in the open state.

Alternatively, the secondary securing device may be designed in such a manner that access to the plug connectors for establishing electrical contact is blocked by the secondary securing device, for example by virtue of the fact that the plug connectors cannot be unscrewed.

Alternatively, active locking of the plug connectors may be provided, for example a pin which moves into a groove and stops the plug connector closure from turning. In this case, locking is possible only when all plug connectors have been inserted.

In one alternative preferred embodiment of the invention, the primary securing device is designed in such a manner that the connection for establishing electrical contact between the at least one battery and the electrical drive of the aircraft can be established only in a closed state of the primary securing device.

The connection for establishing electrical contact between the battery and the electrical drive of the aircraft is preferably formed with a plurality of plug connectors, and the secondary securing device is designed in such a manner that the plug connector grommets are blocked in the open state of the secondary securing device by a hook, a clip or other latching means, for example. As a result, no electrical contact can be established. The aircraft cannot start before the secondary securing device is properly closed and the battery is therefore securely locked in the battery holding device.

In one preferred embodiment of the invention, the at least one primary securing device is in the form of an automatic locking system, and the at least one secondary securing device is in the form of a locking system to be actively actuated. This results in the advantage that the battery is automatically locked by the automatic primary securing device during insertion into the battery holder. As a result, the battery is fixed in the predefined position. The secondary securing device to be actively actuated should be actively closed, for example manually by an operator or in an automated manner by a robot, with the result that the active closing results in a check to ensure that the battery is securely accommodated in the battery holding device.

The object according to the invention is also achieved by a battery system for an electrically driven aircraft having at least one battery holding device and at least one battery.

As is known per se, the battery holding device comprises a battery holder and a primary securing device for locking the at least one battery in the battery holder.

According to the invention, the battery holding device is designed with at least one secondary securing device for locking the at least one battery in the battery holding device. In this case, the secondary securing device can be closed and released independently of the primary securing device.

The battery holding device of the battery system preferably exhibits the above-described features and advantages of the battery holding device according to the invention and/or of a preferred embodiment of the battery holding device.

The battery is preferably in the form of a secondary battery, that is to say a rechargeable battery.

A plurality of batteries are preferably provided. The batteries may be configured individually or as a battery assembly. In particular, the primary and/or the secondary locking of the batteries can be carried out both individually and in the assembly.

A mechanism which provides feedback on correct locking at least of the secondary securing device is preferably provided. This feedback may be in the form of a colored marking, for example, which is visible only in the locked state of the secondary securing device, and/or in the form of electronic feedback and/or in the form of acoustic feedback, for example in the form of a locking noise.

The object according to the invention is likewise achieved by a method for locking at least one battery in a battery holding device of an electrically driven aircraft. For this purpose, as known per se, the following method steps are carried out:

A) inserting the at least one battery into a battery holder of the battery holding device,

B) locking the at least one battery in the battery holder by a primary securing device.

The important factor is that, in a method step C, the at least one battery is additionally locked in the battery holder of the battery holding device by at least one secondary securing device.

The method according to the invention likewise has the above-mentioned advantages of the devices according to the invention and/or of a preferred embodiment of the devices according to the invention.

Method step C is preferably carried out after method step B. However, it is likewise within the scope of the invention for the primary securing device and secondary securing device to be opened and/or closed at the same time. Method step C can therefore also be carried out at the same time as method step B.

The object according to the invention is also achieved by a method for changing a battery in a battery holding device of an electrically driven aircraft. In order to ensure uninterrupted continuous operation and, in particular, to cover longer distances or to enable longer flying times, it is advantageous for electrically driven aircraft if, in the case of intermediate landings of the aircraft, the battery which is then at least partially discharged is replaced with a fully charged battery. This usually results in a very large number of operations of changing the battery.

The method according to the invention for changing a battery comprises, as known per se, the following method steps:

A) releasing primary securing device of at least one battery in a battery holder,

B) removing the battery from the battery holder,

C) inserting at least one new battery into the battery holder,

D) locking the at least one battery in the battery holder by the primary securing device.

The important factor is that at least one secondary securing device is additionally provided and is released in a method step 0 before method step B for removing the battery from the battery holder and/or method step A, and the at least one new battery is locked in the battery holder in a method step E after method step C by the secondary securing device.

In this case, it is within the scope of the invention for method step E to be carried out both directly after method step C, that is to say before method step D or at the same time as method step D. However, method step E is advantageously carried out after method step D.

In an operation of changing the battery, a battery assembly is preferably inserted into a guide of the battery holder, preferably in the form of a V-shaped rail, and is brought to the predefined end position. The battery assembly is preferably locked by the automatic primary securing device by being introduced into the predefined end position. The automatic primary securing device are preferably in the form of an at least one-sided form fit of the battery and battery holder.

In the next step, the secondary securing device are closed manually or by a robot, for example. The secondary securing device may constitute a barrier to making contact between the battery and the drive of the aircraft in the open state. The secondary securing device are preferably in the form of a clip lock, wherein the clip blocks contact with the battery in the open state.

When secondary securing device are closed, the electrical contact is then established between the battery assembly and the electrical drive of the aircraft, for example in the form of plug connections.

During one of the next intermediate landings, the battery or the battery assembly can be replaced, preferably depending on the state of charge of the battery or the battery assembly. In order to remove the battery, the plug connections for connecting the battery and the electrical drive of the aircraft are preferably released. The locking by the secondary securing device can then be released. After releasing the primary securing device, the battery assembly can be removed and can be replaced with a new battery assembly.

In an alternative preferred embodiment of the method according to the invention, contact is made automatically when inserting the battery into the battery holder, so-called blind-mating, in method step C.

In a further preferred embodiment of the method according to the invention, in an additional method step before inserting the battery into the battery holder of the battery holding device and/or before changing the battery, the aircraft is raised at lifting points. In particular, the aircraft is preferably raised at the lifting points to such an extent that spring elements of the aircraft are in an unloaded state.

Batteries and, in particular, battery assemblies may have a comparatively high weight. During an operation of changing the battery, it may therefore be necessary, depending on the weight of the battery or the battery assembly, to secure the aircraft against undesired rebounding or compression of installed spring elements, for example in the landing gear. For this purpose, as described above, the aircraft is raised at defined lifting points to such an extent that the spring elements are in an unloaded state. This avoids relative movements of the aircraft with respect to an auxiliary device which is possibly used to change the battery. In particular, the raising operation means that the reduction in mass caused by the removal of the battery does not result in compressed, prestressed spring elements spontaneously rebounding. The battery base is therefore held at a constant working height. The aircraft is lowered again after the changing operation.

In one preferred embodiment of the method according to the invention, with the closing of the secondary securing device, feedback relating to correct locking of the secondary securing device is provided, in particular in the form of visual feedback, a colored marking, electronic feedback and/or acoustic feedback. This makes it possible to easily ensure that the battery is locked by the secondary securing device.

The invention is suitable, in particular, for a battery holding device of an electrically driven, vertical take-off and landing aircraft. Frequent intermediate landings may occur, in particular, when operating electrically driven, vertical take-off and landing aircraft in urban areas. In order to ensure uninterrupted continuous operation and, in particular, to enable longer flying times, it is advantageous for electrically driven, vertical take-off and landing aircraft if, in the case of intermediate landings of the aircraft, the battery which is then at least partially discharged is replaced with a fully charged battery. This usually results in a very large number of operations of changing the battery. According to the invention, the required safety of the fit of the battery in the battery holding device is ensured despite a large number of changing operations.

### BRIEF DESCRIPTION OF THE DRAWINGS

Further preferred features and embodiments of the battery holding device according to the invention and of the method according to the invention are explained below on the basis of exemplary embodiments and the figures, in which:

FIGS. 1A-1C show a schematic illustration of an exemplary embodiment according to the invention;

FIG. 2 shows a schematic illustration of an exemplary embodiment according to the invention with open secondary securing device;

FIG. 3 shows a schematic illustration of an exemplary embodiment with closed secondary securing device.

### DETAILED DESCRIPTION

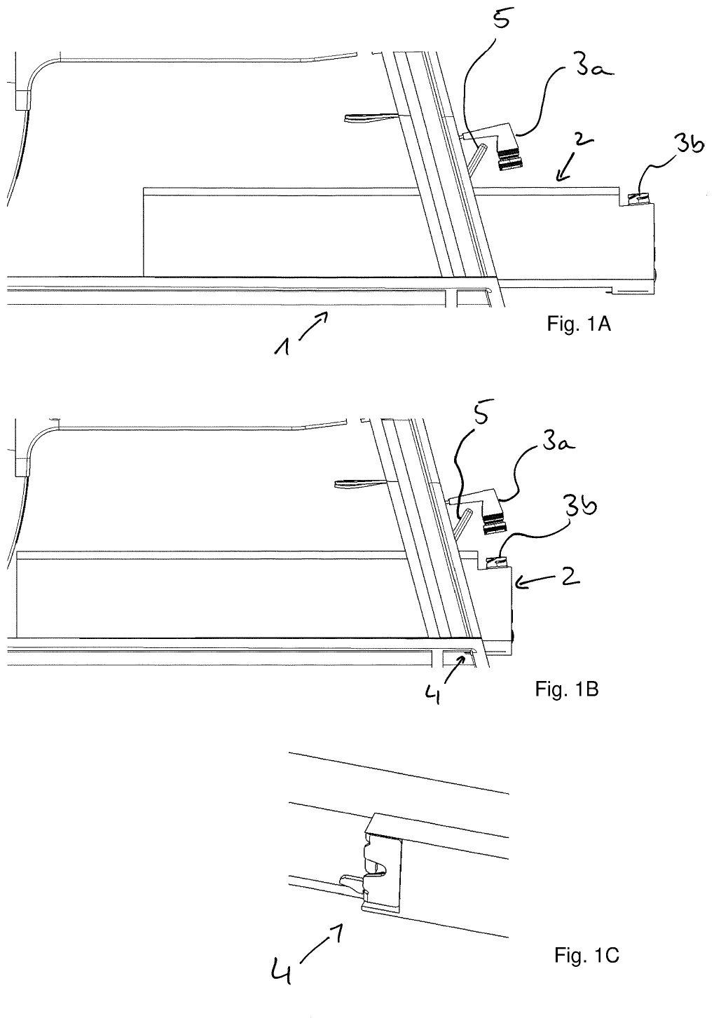

In FIGS. 1A-1C, 2, and 3, identical reference signs denote identical or identically acting elements.

FIG. 1A shows a schematic illustration of a section of an aircraft, the battery holding device in the present case. The battery 2, a battery assembly with nine batteries in the present case, is inserted into the battery holding device 1.

Plug connections 3a, 3b for establishing an electrical connection between the battery 2 and the drive of the aircraft are provided on the battery holding device 1. The plug connector grommets 3a are arranged on the battery holding device 1. The complementary plug connections for plugging in the plug connector grommets 3a are provided on the battery 2.

In the present case, the secondary securing device 5 is in the form of a clip. The secondary securing device 5 is open in the illustration in FIG. 1A.

FIG. 1B illustrates the battery 2 in the inserted state with closed primary securing device 4.

The primary securing device 4 are illustrated in detail in sub-FIG. 1C. In the present case, the primary securing device are in the form of latching hooks, as known from the prior art.

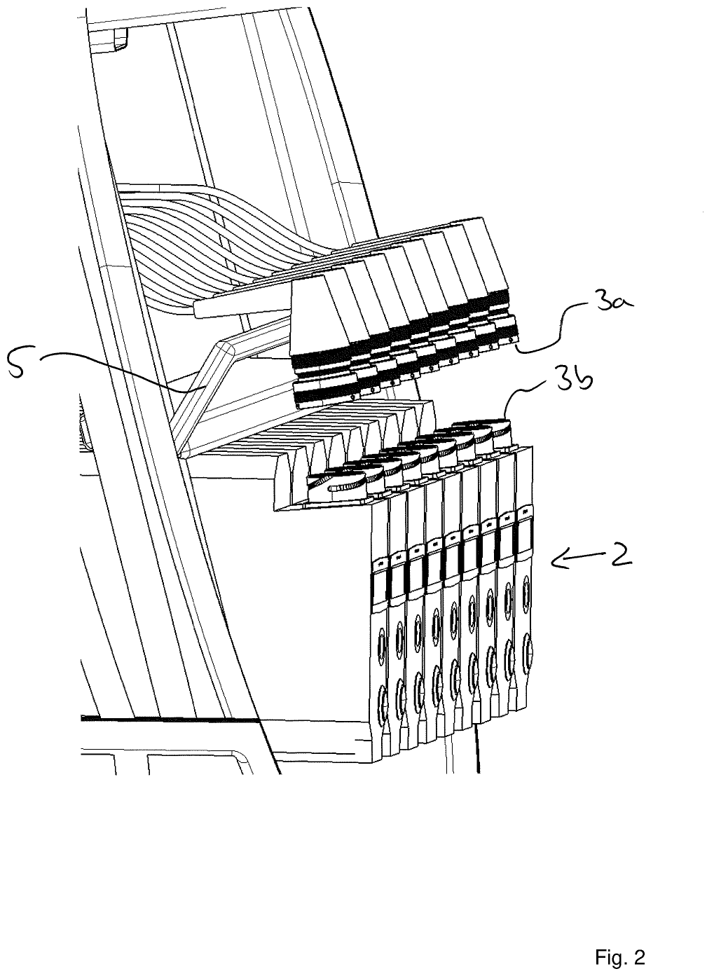

FIG. 2 shows a schematic illustration of a section of a battery holding device after method step D.

The secondary securing device 5 is open and blocks the plug connection 3a, 3b between the battery 2 and the electrical drive of the aircraft. In the present case, the secondary securing device 5 is in the form of a clip. In order to establish the connection, that is to say to make contact with the battery 2 via the plug connectors 3a, 3b, the clip 5 must be closed.

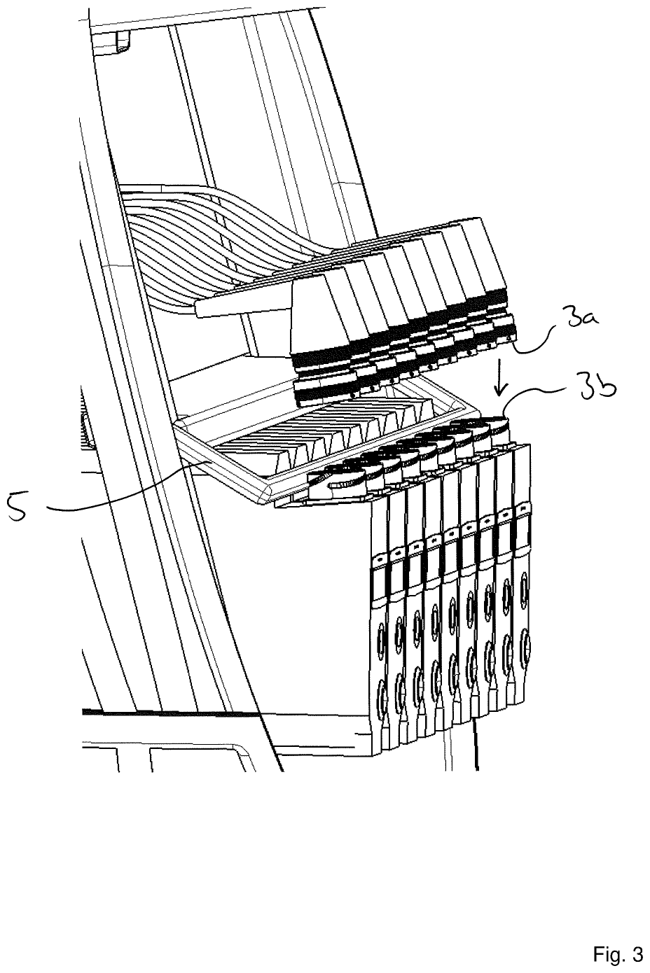

FIG. 3 shows the schematic illustration of the section from FIG. 2 with closed secondary securing device 5.

The clip 5 is closed, with the result that the battery assembly 2 is locked in the battery holder. The closed clip 5 engages with the batteries 2 by being pivoted into and engaging with a corresponding space(s) or recess(es) to hold the batteries 2 in place, and no longer blocks the plug connection between the plug connectors 3a and the battery contact device 3b. The electrical contact can therefore be established between the battery 2 and the drive of the aircraft, as indicated by the arrow.

1. A battery holding device for an electrically driven aircraft, comprising:
a battery holder for accommodating at least one battery;
a connection for establishing electrical contact between the at least one battery and an electrical drive of the aircraft;
a primary securing device for locking the at least one battery in the battery holder; and
at least one secondary securing device for locking the at least one battery in the battery holder, wherein the secondary securing device is closeable and releasable independently of the primary securing device.

2. The battery holding device as claimed in claim 1, wherein the at least one secondary securing device comprises at least one of a mechanical latch, a form fit, at least one hook, or at least one clip.

3. The battery holding device as claimed in claim 1, wherein the at least one secondary securing device is configured such that a connection for establishing electrical contact between the at least one battery and a drive of the aircraft is establishable only in a closed state of the secondary securing device.

4. The battery holding device as claimed in claim 1, wherein the at least one secondary securing device is configured such that the secondary securing device blocks a connection for establishing electrical contact between the at least one battery and a drive of the aircraft in an open state.

5. The battery holding device as claimed in claim 4, wherein the connection for establishing electrical contact includes a plurality of plug connectors and the secondary securing device blocks at least one plug connector grommet in the open state.

6. The battery holding device as claimed in claim 1, wherein the primary securing device comprises an automatic locking system, and the at least one secondary securing device comprises a locking system that requires active actuation.

7. A battery system for an electrically driven aircraft, comprising at least one battery holding device as claimed in claim 1 and at least one battery.

8. A vertical take-off and landing aircraft comprising at least one battery holding device as claimed in claim 1 for at least one replaceable battery.

9. A method for locking at least one battery in a battery holding device of an electrically driven aircraft, the method comprising:
A) inserting the at least one battery into a battery holder of the battery holding device,
B) locking the at least one battery in the battery holder by a primary securing device, and
C) additionally locking the at least one battery in the battery holder of the battery holding device by at least one secondary securing device.

10. A method for changing a battery in a battery holding device of an electrically driven aircraft, the method comprising:
A) releasing a primary securing device of the at least one battery in the battery holder,
B) removing the battery from the battery holder,
C) inserting at least one new battery into the battery holding device,
D) locking the at least one new battery in the battery holder by the primary securing device,
wherein at least one secondary securing device is additionally provided and the method further comprises releasing the secondary securing device in a method step 0 before method step B, and locking the at least one new battery in the battery holder in a method step E after method step C by the at least one secondary securing device.

11. The method as claimed in claim 9, further comprising:
before inserting the at least one battery into the battery holder, raising the aircraft at lifting points to such an extent that spring elements of the aircraft are in an unloaded state.

12. The method as claimed in 9, further comprising upon the closing of the secondary securing device, providing feedback relating to correct locking of the secondary securing device.

13. The method as claimed in claim 12, wherein the feedback comprises at least one of visual feedback, a colored marking, electronic feedback, or acoustic feedback.
